(19) United States
(12) Patent Application Publication
(10) Pub. No.: US 2016/0063691 A1
(43) Pub. Date: Mar. 3, 2016

(54) PLENOPTIC CAMERAS IN MANUFACTURING SYSTEMS

(71) Applicant: Apple Inc., Cupertion, CA (US)

(72) Inventor: Lucas Allen WHIPPLE, Belmont, CA (US)

(21) Appl. No.: 14/476,684

(22) Filed: Sep. 3, 2014

Related U.S. Application Data
(63) Continuation of application No. PCT/US14/53921, filed on Sep. 3, 2014.

(51) Int. Cl. G06T 7/00; G06K 9/52; G06K 9/46; G06K 9/62; H04N 13/02

(52) U.S. Cl. CPC G06T 7/0004; G06T 7/004; G06K 9/6201; H04N 13/02; G06K 9/46; G06K 9/52; G06K 2009/4666

(57) ABSTRACT

The disclosed embodiments relate to using a plenoptic camera in a manufacturing system for various imaging operations. The embodiments include calculating a distance of a manufactured part from a light source or plenoptic camera for further use by a robotic device in the manufacturing system. The embodiments further include compiling a composite two-dimensional or three-dimensional image of a manufactured part in order to derive dimensions of the manufactured part for use by the manufacturing system. Additionally, the embodiments include performing a profile analysis of a surface of a manufactured part based on image data captured by the plenoptic camera. Furthermore, the embodiments discussed herein can be performed on a still or moving manufactured part in order to optimize one or more manufacturing processes.

### CROSS-REFERENCE TO RELATED APPLICATIONS

This application is a continuation of International Application PCT/US 14/53921, with an international filing date of Sep. 3, 2014, entitled “PLENOPTIC CAMERAS IN MANUFACTURING SYSTEMS,” the disclosure of which is incorporated herein by reference in its entirety.

### FIELD

The described embodiments relate generally to manufacturing systems using a plenoptic camera. More particularly, the present embodiments relate to enhancing manufacturing operations by using machine vision incorporating one or more plenoptic cameras.

### BACKGROUND

Advances in manufacturing have provided a variety of techniques for reproducing high quality consumer goods. Many of these techniques incorporate machine vision allowing certain robotic devices to perform advanced operations based on images captured by cameras. However, despite the potential utility of such operations, many camera and vision techniques are subject to various discrepancies. Often times multiple cameras are required in order for a robot to receive both an accurate image of a part and be able to perform a quality operation. Moreover, manufacturing lines can often be forced to stop during image capture, thus slowing down the manufacturing operation. During a pause in manufacturing, multiple cameras may need to capture multiple views of a part, as well as perform post-processing on each image, further delaying the robotic operations to be performed on a part.

### SUMMARY

This paper describes various embodiments that relate to using plenoptic cameras for improving various manufacturing processes. The embodiments discussed herein include a method for identifying a proximity of a manufactured part using a plenoptic camera during a manufacturing process. The method includes a step of generating a plurality of image slices derived from a light field array captured by a plenoptic camera. The light field array is based on a collimated array of light reflected from the manufactured part. The method can further include a step of comparing one or more image slices of the plurality of image slices to a focal distance between the manufactured part and a light source in order to determine the proximity of the manufactured part for use during the manufacturing process.

The embodiments further include a non-transitory computer readable storage medium. The storage medium can include instructions that when executed by a processor in a computing device cause the computing device to perform the steps of iteratively analyzing a plurality of image slices of a light field array captured by a plenoptic camera. The analyzing is performed to identify a region of focus in each image slice of the plurality of image slices. The region of focus corresponds to a point of convergence for a shape of light that is both reflected from a manufactured part at a manufacturing system, and subsequently captured by the plenoptic camera.

Additionally, the embodiments include a manufacturing system for generating a composite image of a moving part using a light field array. The manufacturing system can include a plenoptic camera configured to capture a light field array of a moving part. The manufacturing system can further include an image processing unit communicatively coupled to the plenoptic camera and configured to receive data corresponding to the light field array in order to derive the composite image of the moving part based on a plurality of image slices of the light field array.

Other embodiments discussed herein include an apparatus for generating a three-dimensional composite image of a manufactured part during a manufacturing process. The apparatus can include a plenoptic camera communicatively coupled to a processing unit configured to receive focal field data that corresponds to the manufactured part. The processing unit can further be configured to identify individual image slices of a focal field where a portion of the manufactured part is most coherent, and compile the three-dimensional composite image of the manufactured part based on the individual image slices.

In yet other embodiments, a method for operating a robotic device of a manufacturing system according to image data captured by a plenoptic camera is disclosed. The method can include extracting, from a light field array captured by the plenoptic camera, geometric data corresponding to dimensions of a manufactured part. Additionally, the method can include converting the geometric data into instructions for the robotic device that are capable of causing the robotic device to perform an operation based on the dimensions of the manufactured part.

Furthermore, some embodiments include a manufacturing system having a plenoptic camera configured to provide a light field array to a processing unit. The processing unit can be configured to compile and scale a part image derived from manufactured part data captured in the light field array, and determine whether a defect in the manufactured part exists based on the part image.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a manufacturing system for generating a two-dimensional and/or a three dimensional image of a manufactured part during a manufacturing process.

FIG. 2 illustrates a snapshot view of the light source emitting, and plenoptic camera receiving, collimated light incident upon the manufactured part and the conveyor belt.

FIG. 3 illustrates a perspective representation of a light field array that can be captured by the plenoptic camera, as discussed herein.

FIGS. 4A-4B illustrate an example of image slices from the light field array.

FIG. 5 illustrates examples of the robotic operations that can be based on measurements derived from a light field array captured by a plenoptic camera in the manufacturing system.

FIG. 6 illustrates a method for generating measurements of a manufactured part based on a light field array captured by a plenoptic camera in a manufacturing system.

FIG. 7 illustrates a method to cue a robotic operation based on spatial measurements derived from a light field array captured by a plenoptic camera.

FIG. 8 illustrates a method for generating a scaled image of a manufactured part based on changes in intensity distribution of dots of light incident upon the manufactured part.

FIG. 9 illustrates a manufacturing system configured to use a plenoptic camera to concurrently or simultaneously detect the distance of a manufactured part and perform a surface analysis of a manufactured part.

FIG. 10 illustrates a method for generating location and surface data of a manufacturing part based on a light field array captured by a plenoptic camera during a manufacturing process.

FIG. 11 is a block diagram of a computing device that can represent the components of the computing device, apparatus, systems, subsystems, and/or any of the embodiments discussed herein.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The described embodiments relate to methods, apparatus, and systems for using a multi-lens optical system such as a plenoptic camera. A plenoptic camera is a light field camera having a microlens array to capture multiple views of a scene. In a single instance, the multi-lens optical system can capture four-dimensional light information about the scene and provide various types of spatial data corresponding to the scene captured. The data captured by the multi-lens optical system is a light field array that can be refocused after the scene is captured in order to reveal numerous properties of the scene based on different regions of focus. For example, multiple objects at different distances from the multi-lens optical system can be captured in a single light field array using the multi-lens optical system. The light field array can include image slices that correspond to focused images of the multiple objects, despite differences in distance of the multiple objects from the multi-lens optical system. Using the variability of where an object will appear most focused within the light field array, certain geometric properties can be calculated regarding the object. The embodiments described herein rely on a multi-lens optical system, also referred to as a plenoptic camera, to generate a light field array that can be refocused at various regions to derive spatial and surface related data associated with a manufactured part in a manufacturing process.

During the manufacturing of various parts having diverse geometries, such parts are picked up and placed using different robotic operations. The exchange of manufactured parts can be tedious and time consuming, especially when incorporating machine vision, which often requires the use of multiple cameras and extensive processing in order to intelligently provide controls to the machines executing the robotic operations. In order to improve processing time and optimize the manufacturing process, a plenoptic camera can be incorporated into the manufacturing process in order to quickly derive various measurements based on a light field array captured by the plenoptic camera.

In some embodiments, the plenoptic camera is used to capture a multi-dimensional image of a manufactured part at a point in time in the manufacturing process. The multi-dimensional image or light field array can include numerous image slices that can be analyzed to determine dimensions of the manufactured part. A collimated laser can be used to provide an array of laser points on the manufactured part when the light field array is captured. The various laser points can be incident upon the manufactured part at different regions having different heights relative to the plenoptic camera. Additionally, if the manufactured part has apertures, bends, blemishes, or non-uniform features, the reflected laser points will be modified according to the non-uniform features. Using data regarding the focal point of the laser and depth of field for the plenoptic camera, data can be generated regarding the orientation, surface geometry, and quality of the manufactured part, among other properties of the manufactured part. For example, when a pick and place operation requires the dimensions and orientation of a manufactured part before a robot can grasp the part, a plenoptic camera and a collimated laser can be used to capture a light field array based on the manufactured part. The light field array of the manufactured part can thereafter be processed to determine the orientation and dimensions of a manufactured part relative to a conveyor belt or other surface on which the manufactured part is moving or placed in the manufacturing process. The orientation and area can be converted into robotic instructions for guiding the robot to reach the appropriate area of the conveyor belt where the manufactured part resides, and grasp the manufactured part according to the dimensions calculated from the light field array.

Additionally, in some embodiments, a quick profile analysis of a manufactured part can be derived during a manufacturing process for at least quality and testing purposes. The profile analysis can include a two-dimensional or three-dimensional reconstruction of a manufactured part based on the location of laser points from a collimated laser incident upon the manufactured part. A light field array captured by the plenoptic camera and including the reflected incident laser points can be analyzed to determine how the laser points are modified as a result of being incident upon the manufactured part. By scanning through the light field array and optimizing the focus or coherence of each laser point, a detailed two-dimensional or three-dimensional image of the manufactured part can be generated from a single plenoptic camera. Furthermore, using at least focal point data, pitch between laser points, and field of depth information for the plenoptic camera, slices of the light field array can be converted into a two-dimensional or three-dimensional composite image for analyzing the surfaces of the manufactured part. Both the two dimensional image and/or the three dimensional image can be thereafter used to optimize the manufacturing process. For example, when attempting to machine a smooth surface on the manufactured part, either of the images can be helpful for quickly detecting waviness, dents, flatness, or other surface defects. Upon detection of such defects, the part manufactured part can be scrapped, re-analyzed, re-machined, or forced to undergo some other suitable operation for handling defects of a manufactured part.

In some embodiments, a plenoptic camera can be used during a manufacturing process to calculate the distance of a moving manufactured part and/or perform a profile analysis while the manufactured part is in motion. For example, based on a light field array of the moving manufactured part, the distance of the manufactured part to the plenoptic camera can be derived and used for subsequent manufacturing processes. Contemporaneously, when the light field array includes laser points reflected from the moving manufactured part, a quick profile analysis can be performed on the moving manufactured part, as discussed herein. In this way, multiple steps of a manufacturing process can be combined and optimized by incorporating a plenoptic camera into various manufacturing processes.

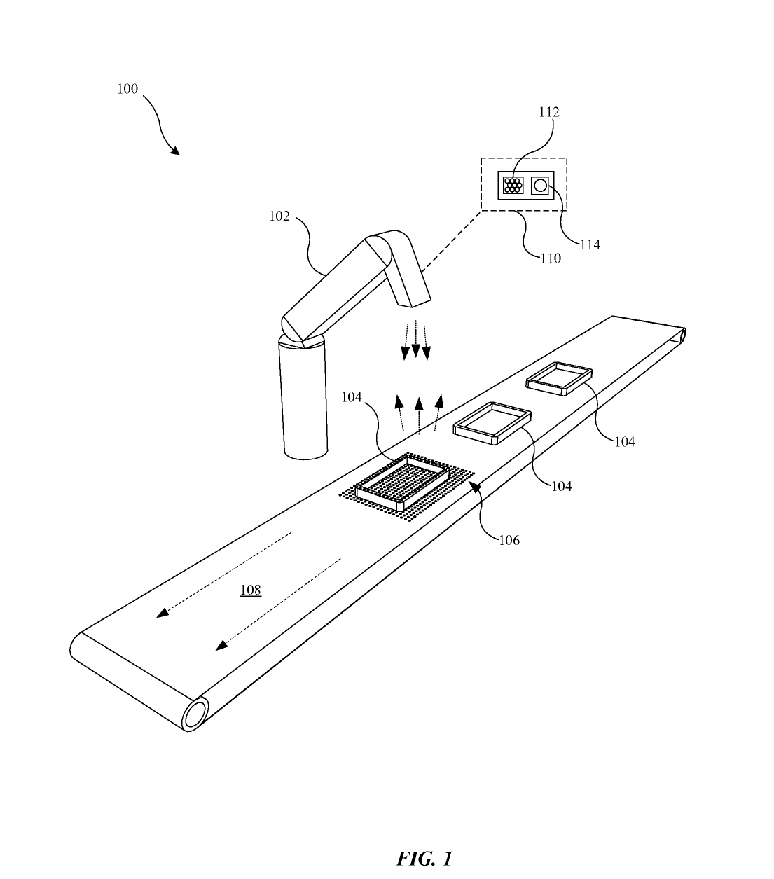

These and other embodiments are discussed below with reference to FIGS. 1-11; however, those skilled in the art will readily appreciate that the detailed description given herein with respect to these figures is for explanatory purposes only and should not be construed as limiting.

FIG. 1 illustrates a manufacturing system 100 for generating a two-dimensional and/or a three-dimensional image of a manufactured part 104 during a manufacturing process. The manufacturing system 100 can incorporate a robotic arm 102 capable of moving in any suitable direction in the x, y, and z plane. The robotic arm 102 can be coupled to a variety of a computers, controllers, and other processing units or devices for sending and receiving data related to the manufacture of the manufactured part 104. During the manufacturing process, a conveyor belt 108 can transfer each of the manufactured parts 104 in increments or continuously toward or away from the robotic arm 102. The robotic arm 102 can include a light source 114 and a plenoptic camera 112, as illustrated in the front view 110 of the robotic arm 102, in order to send and receive light at the robotic arm 102. The light source 114 can include any variety of light sources suitable for collecting image data based on reflected light from a surface of an object. In some embodiments, the light source 114 can include a collimated light source for emitting parallel rays of light onto the manufactured part 104. For example, the parallel rays of light can be laser light having one or more predetermined focal points arranged in predetermined orientations with respect to each other. In some embodiments, and as illustrated in FIG. 1, the light source 114 can emit a grid of single points of light 106 having a uniform or variable pitch or distance between the points of light, and a uniform or variable distribution for the grid of single points of light 106.

The plenoptic camera 112 can be incorporated into the robotic arm 102 or fixed at another area of the manufacturing system 100 in order to receive light reflected from the manufactured part 104. The plenoptic camera 112 can include one or more sensors and microlenses in order to capture various types of image data during the manufacturing process. The robotic arm 102 can move the plenoptic camera 112 into any suitable position around the manufactured part 104. In this way, both the light source 114 and plenoptic camera 112 can be moved contemporaneously as suitable for capturing image data related to the manufactured part. In some embodiments, multiple robotic arms 102 can be used for optimizing the manufacturing system 100 by capturing image data at different stages of the manufacturing process. The image data captured by the plenoptic camera 112 can include a light field array captured at a single moment in time. The light field array can include multiple slices or two-dimensional images having different areas of focus or coherency per image slice or two-dimensional image. Coherency can refer to how detailed and/or focused an object in an image appears. For example, when capturing a light field array based on reflected light from the grid of single points of light 106, some image slices of the light field array will includes areas where the single points of light appear in focus, dense, or otherwise coherent, whereas other image slices of the light field array will include areas where the single points of light appear blurry or out of focus. Depending on the focal distance of the grid of single points of light 106, and the virtual dimensions of the light field array, the dimensions of the manufactured part 104 can be calculated from the light field array. The dimensions can thereafter be provided to another machine or robot in the manufacturing process in order to perform other manufacturing operations on the manufactured part 104, as further discussed herein. Additionally, the dimensions can be used to determine the type of manufactured part 104 that is moving along the conveyor belt 108, which can be useful when different types of manufactured parts 104 need to be differentiated between at one or more steps in the manufacturing process. Moreover, surface quality can be derived from the dimensions in order to determine whether to accept, reject, or further modify a manufactured part 104 during the manufacturing process. For example, the manufactured part 104 can be a computing device housing for a consumer electronics device. During the manufacturing process, a robot can be programmed to accept, reject, or further modify the computing device housing depending on whether the dimensions derived from the light field array correspond to a predetermined set of optimal dimensions stored by a computer memory in the manufacturing process, as discussed herein.

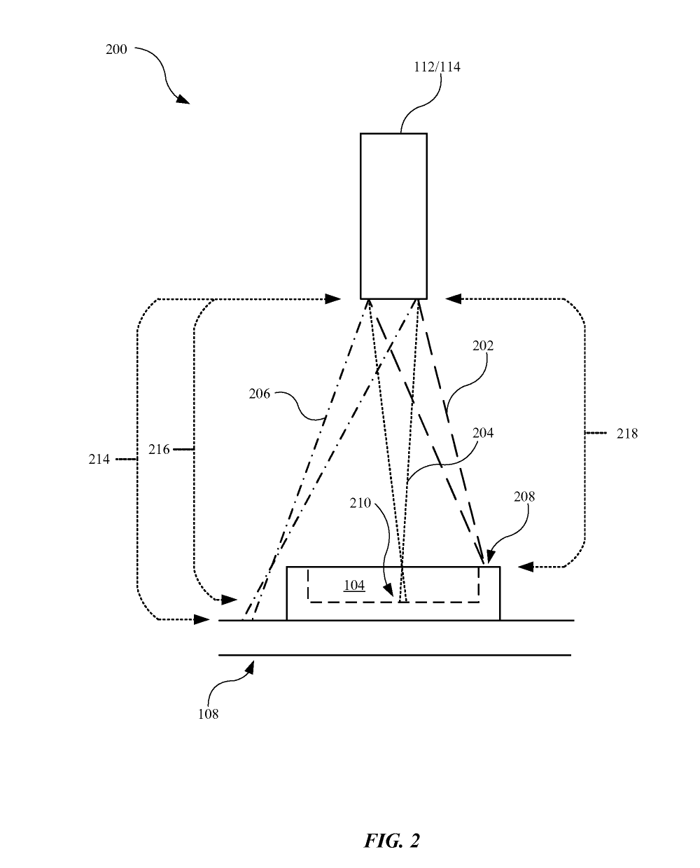

FIG. 2 illustrates a snapshot view 200 of the light source 114 emitting, and plenoptic camera 112 receiving, collimated light incident upon the manufactured part 104 and the conveyor belt 108. Specifically, the snapshot view 200 sets forth an example of how the resolution of a point of incidence of a ray of light can vary based on the dimensions of a surface of incidence (e.g., the conveyor belt 108 and/or the manufactured part 104). As discussed herein, the grid of single points of light 106 can be incident upon the manufactured part 104 and/or the conveyor belt 108. The reflected arrays of light (e.g., 202, 204, 206) from the manufactured part 104 and the conveyor belt 108 can thereafter be captured by the plenoptic camera 112. For example, the collimated light source 114 can provide a plurality of lasers configured to have a focal point 208 at or proximate to a protruding region of the manufactured part 104 (e.g., a raised edge). A first reflected ray 202, reflected from the protruding region will appear most dense when compared to other reflected arrays incident upon regions of the manufactured part 104 if the focal point 208 is configured to be near the protruding region. For example, a second reflected ray 204 can be reflected from a cavity 210 of the manufactured part 104, which is at a height below the focal point 208. As a result, the second reflected ray 204 will appear less focus or coherent than the first reflected ray 202. For example, if the light source 114 included dots or points of light, the dots reflected in the first reflected ray 202 will appear more uniform, coherent, or dense, and the dots reflected in the second reflected ray 204 will appear less dense or blurry. A third reflected ray 206 will appear even less focused because the third reflected ray 206 is reflected from the conveyor belt 108, which is a further distance from the focal point 208.

Based at least on data regarding the reflected rays (202, 204, 206), the plenoptic camera 112, and the conveyor belt 108, measurements of the manufactured part 104 can be generated. For example, a first distance 218, defined as the distance between the plenoptic camera 112, or the light source 114, and the focal point 208, can be a stored quantity during the manufacturing process. The conveyor distance 214, defined as the distance between the light source 114 and the conveyor belt 108 can also be a stored quantity that can be used when generating the dimensions of the manufactured part 104. For example, using a light field array captured by the plenoptic camera 112, a processing unit communicatively coupled to the plenoptic camera 112 can determine whether a ray of light from the light source 114 is incident at a focal point 208 for the light source. Based on this determination, the processing unit can deduce that the height of the manufactured part where the ray of light is incident at a focal point 208 is the conveyor distance 214 minus the first distance 218 (i.e. the focal distance). This process can also be used to differentiate between the manufactured part 104 and the conveyor belt 108. For example, as discussed herein, the distribution of the dots of light incident upon the conveyor belt 108 can depend on the distance between the light source 114 emitting the dots of light and the conveyor belt 108. Moreover, the distribution of the dots of light incident upon the manufactured part 104 can depend on the distance between the light source 114 and the manufactured part 104. This occurs because the dots of light can become more or less dense or diffuse depending on a distance between the light source 114 and the incident surface receiving the incident dots of light. Additionally, for collimated light in focus, the peak amplitude of the intensity of the reflected light incident at the plenoptic camera will be much higher and the distribution of the collimated light will be more tightly grouped than collimated light out of focus. When the collimated light is out of focus the peak amplitude of the intensity will be lower and the distribution of the collimated light will be wider or more diffuse. By comparing the various ratios of intensity, peak intensity, diffusion, or pitch of the dots, and incident surface distances from the light source 114, various surface dimensions can be calculated by the processing unit coupled to the manufacturing system 100. The intensity, peak intensity, or pitch measurements for one or more dots of light can be derived from the light field array captured by the plenoptic camera 112. The peak intensity can refer to the maximum intensity measured out of one or more intensity measurements for a group of dots or single dot present in one or more slices of the captured light field array. Additionally, the various surface dimensions that can be derived include circumference, area, total perimeter distance, volume, height, width, angles, among other features of a manufactured part or portion of a manufactured part. It should be noted that the term manufactured part can refer to any material or object that is or will be the subject of a manufacturing operation. Upon calculating one or more of the various surface dimensions, the manufacturing system can execute various manufacturing operations based on one or more of the surface dimensions.

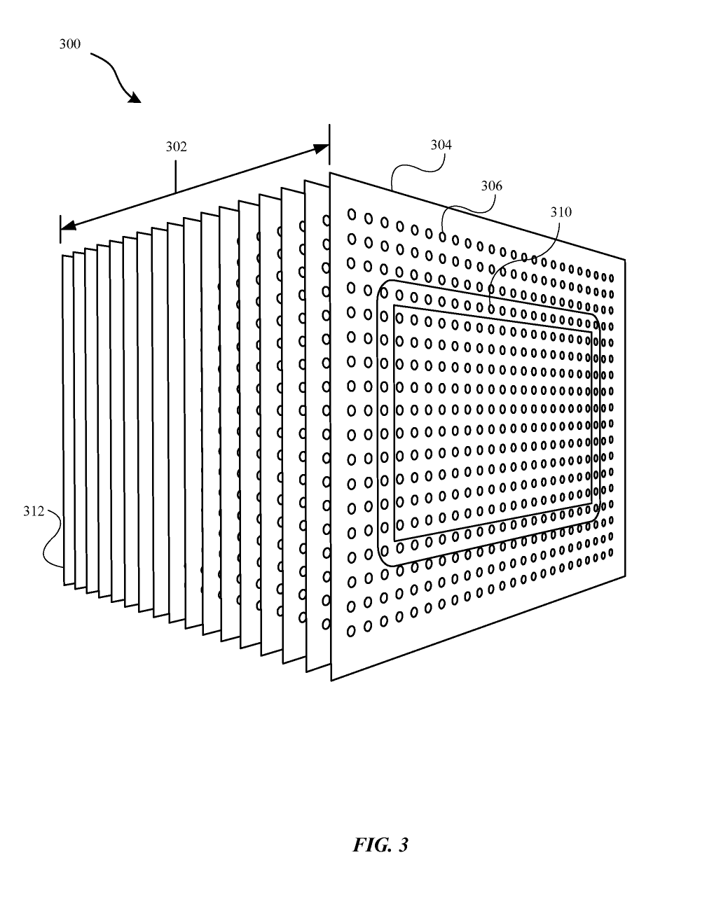

FIG. 3 illustrates a perspective representation of a light field array 300 that can be captured by the plenoptic camera 112, as discussed herein. The light field array 300 is a data object that can be the entire light field array captured by the plenoptic camera 112 at a single instance in time, or a subset of a light field array captured by the plenoptic camera 112. A first slice 304 of the light field array can include a two-dimensional image of dots or shapes of light (e.g., of the grid of single points of light 106) incident upon both the conveyor belt 108 and the manufactured part 104. The manufactured part dots 310 (i.e., light reflected from the manufactured part) can appear more focused or dense than the conveyor belt dots 306 (i.e., light reflected from the conveyor belt) when the dots of light are configured to have a focal point at the top of the manufactured part 104. In some embodiments, the focal point is configured to be at the surface of the conveyor belt 108. In this way, the dots of light will appear most dense or coherent at the conveyor belt 108, and less dense when the dots of light are incident upon an object abutting the conveyor belt 108. Additionally, depending on the focal point, the intensity or pitch measurements of the dots of light can be different at the conveyor belt 108 than the intensity or pitch measurements of the dots of light incident upon an object abutting the conveyor belt 108. This can result from the dots of light spreading out or becoming more or less diffuse over distances longer or shorter than the focal point.

As second slice 312 can be representative of where the conveyor belt dots 306 stop spreading out because of their termination at or incidence upon the conveyor belt 108. Using the differences in intensity or pitch of the conveyor belt dots 306 at the second slice 312 and the manufactured part dots 310 at the first slice 304, along with an array length 302, the actual distance between the conveyor belt 108 and the perimeter of the manufactured part 104 can be derived. Additionally, other measurements of the manufactured part 104, such as width, volume, thickness, and height, can be derived from the light field array 300 captured using the plenoptic camera 112 and some post-processing at a processing unit of the manufacturing system 100. In some embodiments, the array length 302 can measure a subset of a longer light field array that has been condensed in order to derive a subset light field array the has a first slice 304 that includes dots of light of a particular first intensity or pitch, and a second slice 312 that includes dots of light of a particular second intensity or pitch. The processing unit of the manufacturing system 100 can also sort through the light field array to generate a subset of slices that each include dots of light having a certain pitch, intensity, range of pitches and/or intensities, diameter, wavelength, and/or other properties suitable for deriving geometric data using a light field array.

This geometric data can in some embodiments be used to compile a composite three-dimensional image of the manufactured part 104, which can be helpful when performing a profile analysis of the manufactured part, as discussed herein. Additionally, the composite three-dimensional image can be used to estimate volume, as well as other properties of the manufactured part. For example, if a density of the manufactured part is known, the weight of the manufactured part can be estimated based on the estimated volume derived from the composite three-dimensional image. Moreover, because the light field array is captured at a single instant in time during the manufacturing process, the various properties of the manufactured part can be estimated more efficiently than other existing scanning devices. In some embodiments, the composite three-dimensional image can be used to determine whether certain features (e.g., apertures in a device housing) of the manufactured part have been machined appropriately. Furthermore, when more than one composite three-dimensional image has been compiled, the processing unit of the manufacturing system can test whether the combination of the composite three dimensional images will interact according to a predetermined design specification. For example, a composite three dimensional image of a device button can be compared to a composite three-dimensional image of an aperture in a device housing to ensure that the button will fit into the aperture according to a predetermined design specification. In this way, individual parts can be matched together during a manufacturing process using data from a plenoptic camera.

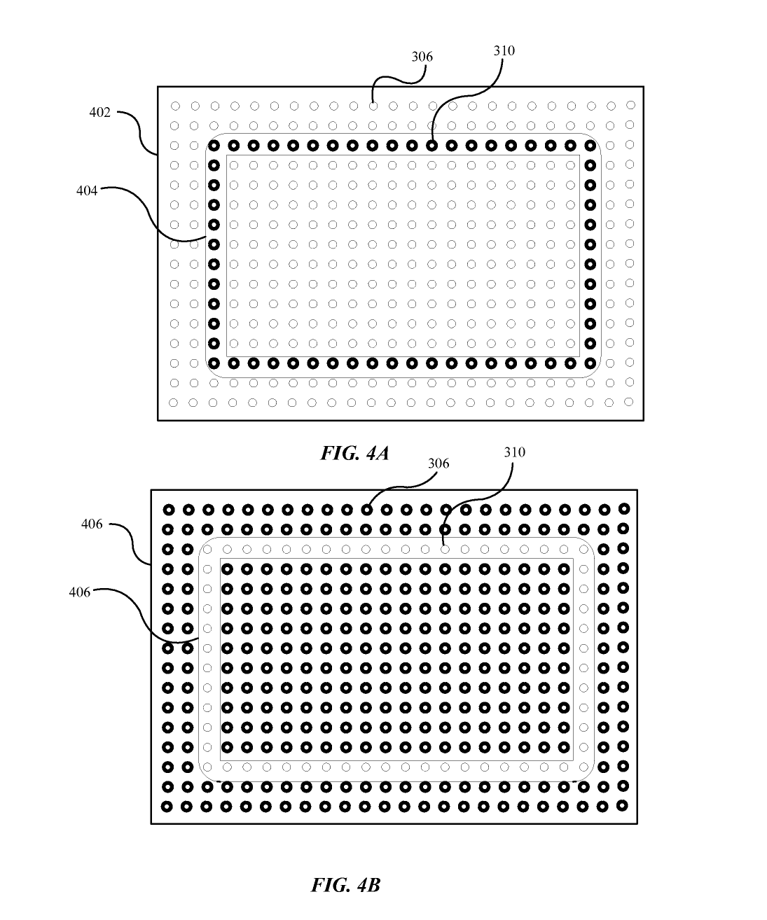

FIGS. 4A-4B illustrate an example of slices from the light field array 300. At a slice 402 of FIG. 4A, the manufactured part dots 310 can appear more focused when the dots or shapes of light are configured to have a focal point on, near, or proximate to the perimeter 404 of the manufactured part 104. Additionally, because the manufactured part dots 310 are in focus at the slice 402, the conveyor belt dots 306 will appear less focused or coherent because the point of incidence is at the conveyor belt 108, which is a further distance away from the light source 114 than the perimeter 404 and the manufactured part dots 310. Using this difference in focus or coherence, geometric data can be derived for the manufactured part 104. Slice 406 of FIG. 4B is an example of when the focal point of the dots of light are configured to be at the conveyor belt 108, thus causing the conveyor belt dots 306 to be more dense or focused and the manufactured part dots 310 to be less focused. In this way, the location of slice 406 and/or slice 402 within the light field array 300 can be used to determine geometric properties of objects appearing in each image slice because the focal point of each dot of light is a predetermined distance from the light source 114, to which other less focused or less coherent dots of light can be compared.

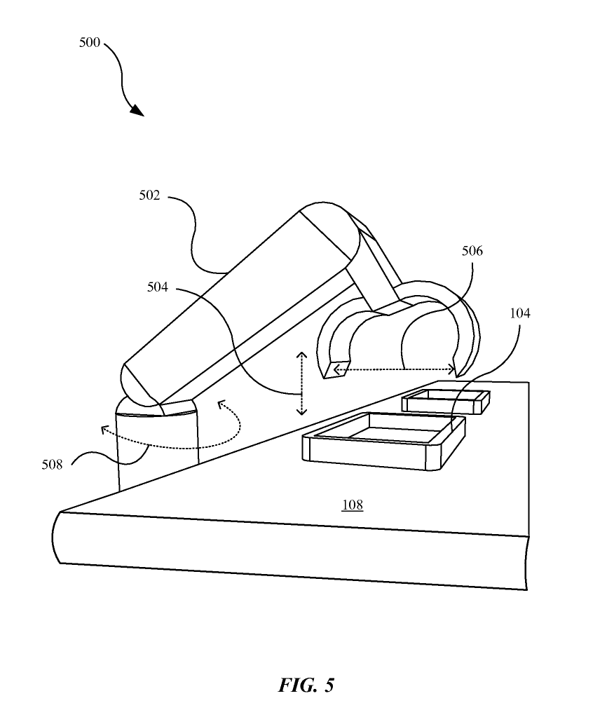

FIG. 5 illustrates examples of the robotic operations that can be based on measurements derived from a light field array captured by a plenoptic camera 112 in the manufacturing system 100. Specifically, FIG. 5 sets forth a robot 502 capable of performing a variety of robotic operations in a variety of directions based on measurements derived from a light field array. For example, when the robot 502 is performing a pickup operation, the robot 502 can be provided a rotate command for turning the robot 502 in a rotational direction 508 based on where the manufactured part 104 is determined to be on the conveyor belt 108 according to the light field array. The height of the manufactured part 104 can be used to derive a reach command for causing the robot 502 to move in a z-direction 504 relative to the conveyor belt 108. The robot 502 can also receive a grasp command based on a width of the manufactured part 104 determined based on the light field array. The width of the manufactured part 104 can be translated into the grasp command, which causes the robot 502 to open or close a gripping portion of the robot 502 according to a grip distance 506. Measurements derived from the light field array captured by the plenoptic camera 112 can be the basis for any suitable robotic or manufacturing operation. For example, the plenoptic camera 112 can capture a light field array that can be the basis for robotic or manufacturing operations performed by a cartesian robot, 6-axis robot, scara robot, dual arm robot, painting or finishing robot, welding robot, spherical robot, articulated robot, gantry robot, or any other machine that can receive commands from a processing unit (e.g., a computer or controller) during a manufacturing process.

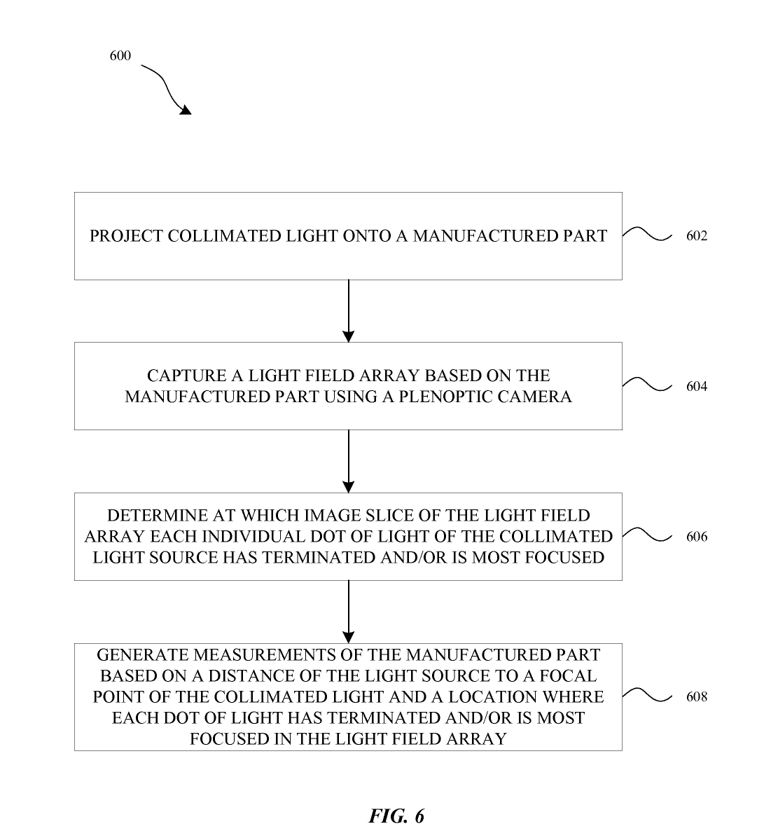

FIG. 6 illustrates a method 600 for generating measurements of a manufactured part based on a light field array captured by a plenoptic camera in a manufacturing system. The method 600 can be performed by the processing unit discussed herein, or any other system or apparatus suitable for controlling the imaging of a manufactured part. The method 600 includes a step 602 of projecting collimated light onto the manufactured part. The collimated light can include dots, circles, ellipses, polygons, or any other suitable shape for analyzing the geometry of an object. The method 600 further includes a step 604 of capturing a light field array based on the manufactured part using a plenoptic camera, as further discussed herein. The light field array can be captured when the manufactured part is moving or still in some embodiments. Additionally, the light field array can include reflected light from the collimated light incident upon the manufactured part. The method 600 can also include a step 606 of determining at which image slice of the light field array each individual dot or shape of light of the collimated light source is most focused. Step 606 can be performed for each individual dot or shape of light in order determine all the image slices that include a dot or shape of light that is most focused. Additionally, at step 608, measurements of the manufactured part are generated based on the distance of the light source to a focal point of the collimated light and a location where each dot of light terminates or is most focused, coherent, or dense in the light field array. The location where each dot is most focused depends on the location of the slice within the light field array that includes a representation of the dot that is most focused. Using the generated measurements, a robot or other machine of a manufacturing system can be provided with coordinates in order reach the manufactured part, or otherwise perform an operation on the manufactured part.

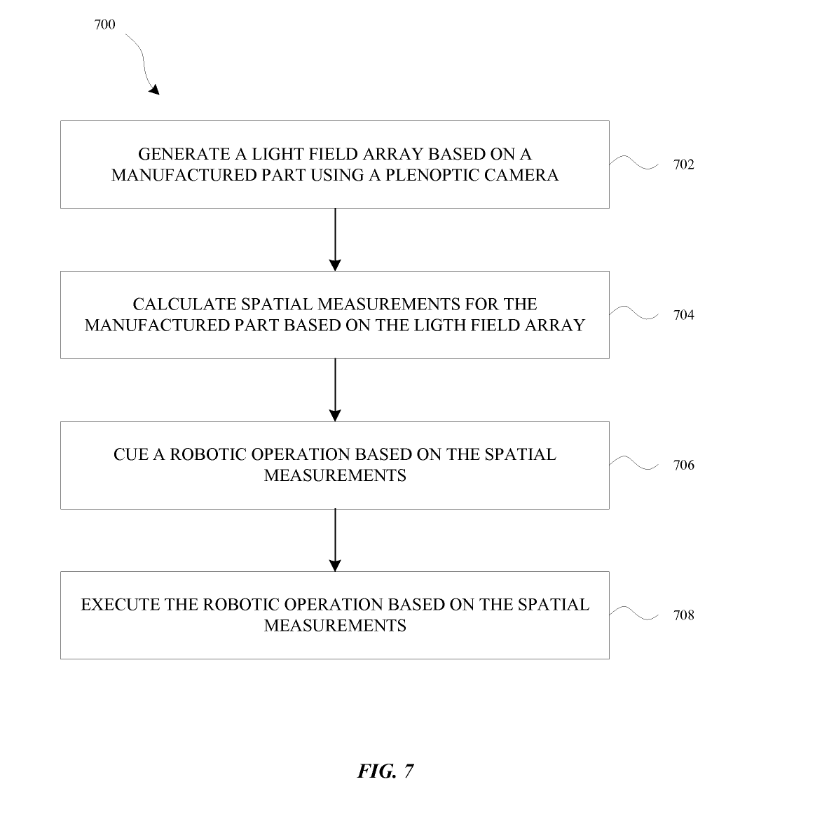

FIG. 7 illustrates a method 700 to cue a robotic operation based on spatial measurements derived from a light field array captured by a plenoptic camera. The method 700 can be performed by the processing unit discussed herein, or any other system or apparatus suitable for controlling the imaging of a manufactured part. The method 700 can include a step 702 of generating a light field array based on a manufactured part using a plenoptic camera, as further discussed herein. The method 700 can further include a step 704 of calculating spatial measurements for the manufactured part based on the light field array. The spatial measurements can include the distance of the manufactured part from the plenoptic camera, a light source, or other suitable reference location. The spatial measurements can be based on predetermined information about the size and/or shape of the manufactured part. For example, if the processing unit is aware that the manufactured part is circular, the processing unit can compare the radius of the circular manufactured part in a slice of the light field array to a reference radius of the circular manufactured part. The reference radius of the manufactured part can correspond to when the circular manufactured part is at a certain location in the field of depth of a plenoptic camera. Using a ratio between the radius and reference radius, a distance to the circular manufactured part can be determined, among other spatial measurements. This example can also be applied to any other manufactured part having measurable features.

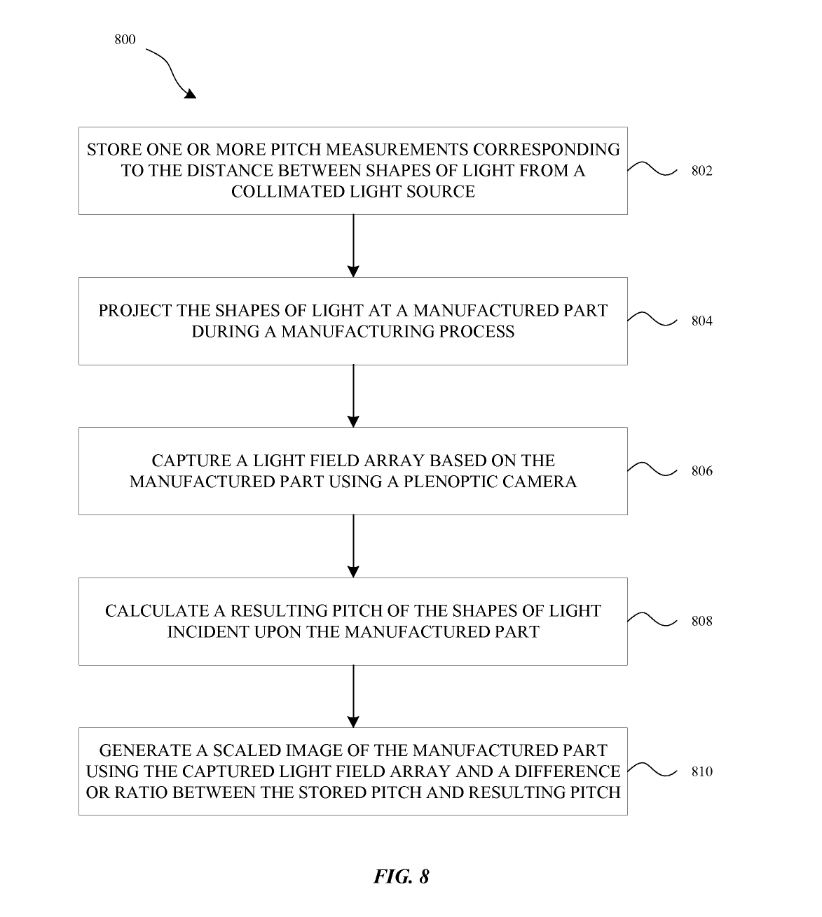

FIG. 8 illustrates a method 800 for generating a scaled image of a manufactured part based on one or more differences in intensity, peak intensity, and/or pitch of dots of light incident upon the manufactured part. The method 800 can be performed by the processing unit discussed herein, or any other system or apparatus suitable for controlling the imaging of a manufactured part. The method 800 can include a step 802 of storing one or more intensity and/or pitch measurements at a memory. At step 804, the collimated light source is projected onto a manufactured part during a manufacturing process. During this method, the manufactured part can be still or moving. The method can further include a step 806 of capturing a light field array based on the manufactured part using a plenoptic camera. At step 808, a resulting intensity and/or pitch measurement of the dots or shapes of light incident upon the manufactured part can be calculated. At step 810, a scaled image of the manufactured part can be generated using the captured light field array and a difference between, or a ratio of, the stored intensity and/or pitch measurements and the resulting intensity and/or pitch measurements of the shapes of light. The scaled image can be useful for performing a subsequent manufacturing operation on the manufactured part, or testing the quality of a completed manufacturing operation. Moreover, the methods, systems, and apparatus discussed herein can be used to determine any surface defects on a manufactured part having transparent layers. In this way, because light will reflect differently from a transparent layer than a non-transparent layer, certain features of the manufactured part can be inferred and analyzed based on one or more of the methods, apparatus, and systems discussed herein using a plenoptic camera.

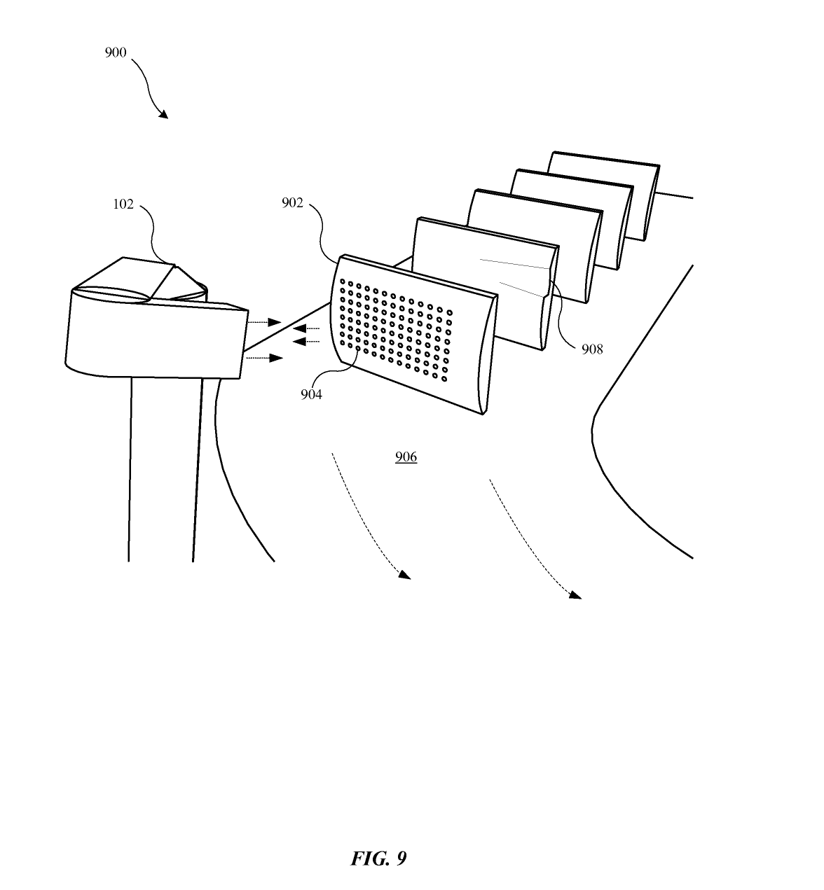

FIG. 9 illustrates a manufacturing system 900 configured to use a plenoptic camera to concurrently or simultaneously detect the distance of a manufactured part and perform a surface analysis of a manufactured part. Specifically, the manufacturing system 900 can derive a distance of the manufactured part from a light source and analyze a surface of the manufactured part 902 based on a single light field array captured by a plenoptic camera of the robotic arm 102. The robotic arm 102, as discussed herein, can include a light source and plenoptic camera. The light source can be a collimated light source for projecting one or more dots or shapes of light 904 onto the surface of the manufactured part 902. Light reflected from the surface can be captured in the light field array for post-processing by a processing unit communicatively coupled to the plenoptic camera. The light field array can be captured concurrently with the moving of the manufactured part 902 over a conveyor belt 906 or any other suitable mechanism for transferring a manufactured part in a manufacturing system. Using data from the light field array, the distance of the part can be determined and provided to one or more subsystems of the manufacturing system 900 for optimizing the performance of the manufacturing system. Additionally, when a manufactured part includes a defect 908, as illustrated in FIG. 9, the light field array can be used to quickly detect the defect 908 in the surface of the manufactured part, and a subsystem of the manufacturing system 900 can respond accordingly. For example, the defective manufactured part can be rejected or further processed by the manufacturing system 900, as further discussed herein.

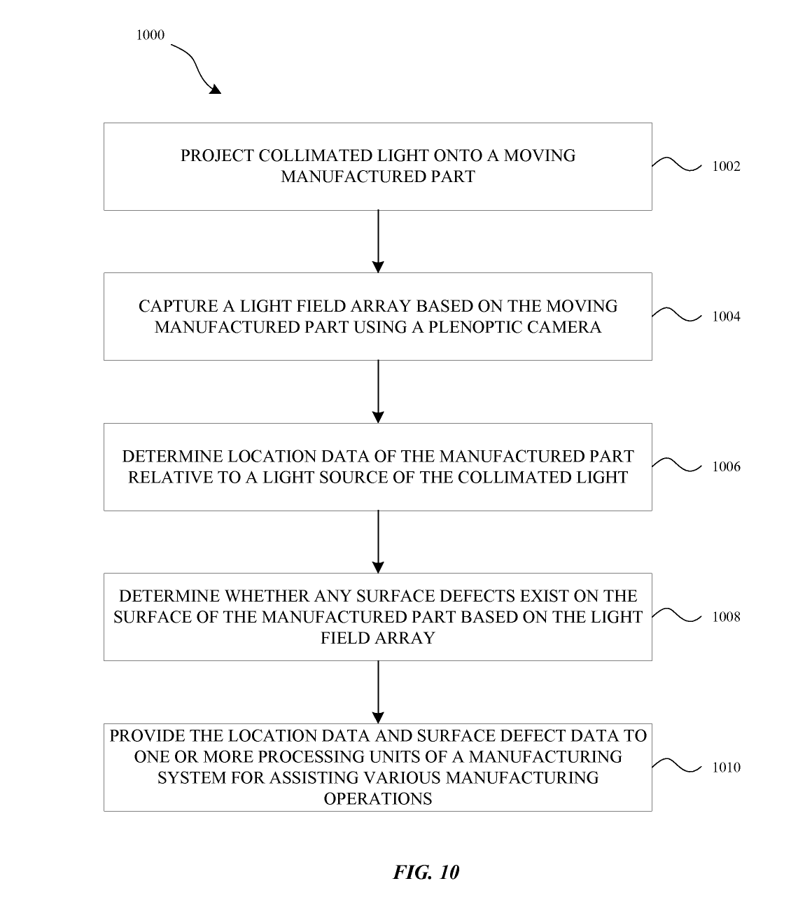

FIG. 10 illustrates a method 1000 for generating location and surface data based on a light field array captured by a plenoptic camera during a manufacturing process. The method 1000 can be performed by the processing unit discussed herein, or any other system or apparatus suitable for controlling the imaging of a manufactured part. The method 1000 can include a step 1002 of projecting collimated light onto a moving manufactured part. At step 1004, a light field array is captured based on the manufactured part using a plenoptic camera. At step 1006, location data of the manufactured part is determined related to a light source of the collimated light. At step 1008, any surface defects at the surface of the manufactured part are determined based on the light field array. The determination of surface defects can be based on two-dimensional slices from the light field array or a composite three-dimensional image derived from the light field array, as discussed herein. At step 1010, location data and surface defect data are provided to one or more processing units of the manufacturing system for assisting with other manufacturing operations.

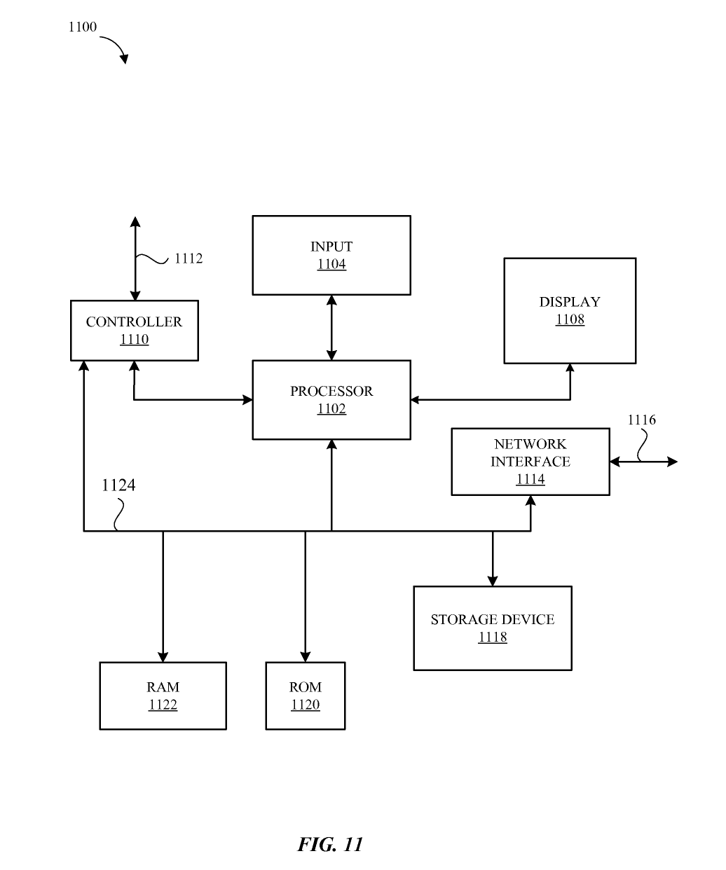

FIG. 11 is a block diagram of a computing device 1100 that can represent the components of the manufacturing system, processing unit, computing device, apparatus, systems, subsystems, and/or any of the embodiments discussed herein. It will be appreciated that the components, devices or elements illustrated in and described with respect to FIG. 11 may not be mandatory and thus some may be omitted in certain embodiments. The computing device 1100 can include a processor 1102 that represents a microprocessor, a coprocessor, circuitry and/or a controller for controlling the overall operation of computing device 1100. Although illustrated as a single processor, it can be appreciated that the processor 1102 can include a plurality of processors. The plurality of processors can be in operative communication with each other and can be collectively configured to perform one or more functionalities of the computing device 1100 as described herein. In some embodiments, the processor 1102 can be configured to execute instructions that can be stored at the computing device 1100 and/or that can be otherwise accessible to the processor 1102. As such, whether configured by hardware or by a combination of hardware and software, the processor 1102 can be capable of performing operations and actions in accordance with embodiments described herein.

The computing device 1100 can also include user input device 1104 that allows a user of the computing device 1100 to interact with the computing device 1100. For example, user input device 1104 can take a variety of forms, such as a button, keypad, dial, touch screen, audio input interface, visual/image capture input interface, input in the form of sensor data, etc. Still further, the computing device 1100 can include a display 1108 (screen display) that can be controlled by processor 1102 to display information to a user. Controller 1110 can be used to interface with and control different equipment through equipment control bus 1112. The computing device 1100 can also include a network/bus interface 1114 that couples to data link 1116. Data link 1116 can allow the computing device 1100 to couple to a host computer or to accessory devices. The data link 1116 can be provided over a wired connection or a wireless connection. In the case of a wireless connection, network/bus interface 1114 can include a wireless transceiver.

The computing device 1100 can also include a storage device 1118, which can have a single disk or a plurality of disks (e.g., hard drives) and a storage management module that manages one or more partitions (also referred to herein as “logical volumes”) within the storage device 1118. In some embodiments, the storage device 1118 can include flash memory, semiconductor (solid state) memory or the like. Still further, the computing device 1100 can include Read-Only Memory (ROM) 1120 and Random Access Memory (RAM) 1122. The ROM 1120 can store programs, code, instructions, utilities or processes to be executed in a non-volatile manner The RAM 1122 can provide volatile data storage, and store instructions related to components of the storage management module that are configured to carry out the various techniques described herein. The computing device 1100 can further include data bus 1124. Data bus 1124 can facilitate data and signal transfer between at least processor 1102, controller 1110, network interface 1114, storage device 1118, ROM 1120, and RAM 1122.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1.-20. (canceled)

21. A manufacturing system for generating a composite image of a moving part using a light field array, the manufacturing system comprising:
a plenoptic camera configured to capture the light field array of the moving part; and
an image processing unit communicatively coupled to the plenoptic camera and configured to receive data corresponding to the light field array in order to derive the composite image of the moving part based on at least one image slice of the light field array.

22. The manufacturing system as in claim 21, wherein the moving part is a component of an electronic device.

23. The manufacturing system as in claim 21, wherein the composite image is a three-dimensional image of the moving part.

24. The manufacturing system as in claim 21, wherein the image processing unit is further configured to isolate features corresponding to the moving part in the at least one image slice.

25. The manufacturing system as in claim 21, wherein the composite image is a two-dimensional image based on one or more coherent perspective views of the moving part represented in the at least one image slice.

26. The manufacturing system as in claim 21, further comprising:
a robotic device communicatively coupled to the image processing unit and configured to execute robotic operations based on the composite image of the moving part.

27. The manufacturing system as in claim 21, wherein the processing is further configured to identify a surface defect of the moving part based on the light field array.

28. The manufacturing system as in claim 21, wherein the plenoptic camera is configured to periodically capture one or more light field arrays each corresponding to different moving parts being transferred through the manufacturing system.

29. The manufacturing system of claim 21, wherein the image processing unit is configured to identify a type of moving part based on the light field array.

30. The manufacturing system as in claim 21 wherein the image processing unit is configured to provide operational instructions to a robotic device based on one or more dimensions of the moving part derived from the composite image.

31. A manufacturing system, comprising:
a plenoptic camera configured to provide a light field array, based on a manufactured part, to a processing unit configured to:
compile and scale a part image derived from part data captured in the light field array; and
determine whether a defect in the manufactured part exists based on the part image.

32. The manufacturing system as in claim 31, wherein the part image is based on one or more coherent perspective views of the manufactured part represented in one or more image slices generated from the part data.

33. The manufacturing system as in claim 32, wherein the processing unit is configured to isolate features corresponding to the manufactured part in one or more of the one or more image slices.

34. The manufacturing system as in claim 31, wherein the processing unit is further configured to cause a robotic device to perform an operation on the manufactured part based on whether a defect in the manufactured part exists.

35. The manufacturing system as in claim 31, wherein the part image is a three-dimensional composite image.

36. The manufacturing system as in claim 31, further comprising a collimated light source configured to project a plurality of shapes of light onto the manufactured part.

37. The manufacturing system as in claim 31, wherein the processing unit determines whether the defect in the manufactured part exists based on whether a reflected pitch of two shapes of light reflected from the manufactured part is different than an original pitch of the two shapes of light before being incident upon the manufactured part.

38. The manufacturing system as in claim 31, wherein the processing unit determines whether the defect in the manufactured part exists based on a comparison between a change in coherency of a shape of light between at least two image slices derived from the part data.

39. The manufacturing system as in claim 31, wherein scaling the part image includes increasing a size of an originally compiled part image generated based on the part data.

40. The manufacturing system as in claim 31 wherein the processing unit determines whether the defect in the manufactured part exists based on a comparison between the part image and a reference part image stored in a memory of the manufacturing system.
